(19) United States
(12) Patent Application Publication
(10) Pub. No.: US 2015/0025853 A1
(43) Pub. Date: Jan. 22, 2015

(54) SYSTEM AND METHOD FOR MODULAR DESIGN

(71) Applicant: SHEA HOMES LIMITED PARTNERSHIP, SCOTTSDALE, AZ (US)

(72) Inventors: HOWARD ENGLANDER, LAGUNA BEACH, CA (US); MARTIN REILL, GLENDALE, AZ (US)

(21) Appl. No.: 13/943,732

(22) Filed: Jul. 16, 2013

(51) Int. Cl. G06F 17/50

(52) U.S. Cl. CPC G06F 17/5004
USPC 703/1

(57) ABSTRACT

A system for providing a selectable living area according to various aspects of the present invention is configured to provide a method for allowing a predetermined area within a floor plan to be selectively modified without altering areas of the floor plan outside of the predetermined area. In one embodiment, the system for providing a selectable living area comprises a floor plan having a centric living space absent of configuration details and a set of modular options that are configured to be located within the centric living space to provide a floor plan with complete design features. The set of modular options may provide a series of design configuration choices that allow the centric living space to be selected by a homebuyer according to their desired living preferences.

### BACKGROUND OF THE INVENTION

The home building industry provides housing to home buyers through three primary methods. One of these methods is custom built homes in which an architect designs a home based on the instructions of the home buyer Due to the uniqueness of the designed home, this method is often only used for more expensive homes or in housing developments here each home is individualized. A second method is a community based neighborhood in which a home builder creates multiple floor plans that are presented to potential home buyers for consideration. A homebuyer selects a floor plan and the home is built, often with very little variation from the plan. This method takes of economies of scale by reducing the amount of customization that a homebuyer may make to the selected floor plan. As a result of the reduced variability from home to home, this method is particularly well suited for large scale home building that provides affordable lo pricing for many homebuyers.

The third method is the semi-custom built home. This method often allows a homebuyer to select a pre-designed floor plan and make slight modifications according to their preferences. The pre-designed floor plan is then adjusted to account for the modifications. While commonly less expensive than a custom built home, this method is often more expensive than homes build strictly according to a floor plan and may not be particularly well suited for largo scale production.

### SUMMARY OF THE INVENTION

A system for providing a selectable living area according to various aspects of the present invention is configured to provide a method for allowing a predetermined area within a floor plan to be selectively modified without altering areas of the floor plan outside of the predetermined area. In one embodiment, the system for providing a selectable living area comprises a floor plan having a centric living space absent of configuration details and a set of modular options that are configured to be located within the centric living space to provide a floor plan with complete design features. The set of modular options may provide a series of design configuration choices that allow the centric living space to be selected by a homebuyer according to their desired living preferences.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements and steps throughout the figures.

FIG. 1A representatively illustrates a two story floor plan from among a set of floor plans having an open centric space according to various aspects of the present invention;

FIG. 1B representatively illustrates a single story floor plan from among: the set of floor plans having an open centric space according to various aspects of the present invention;

FIG. 1C representatively illustrates a second single story floor plan from among the set of floor plans having an open centric space according to various aspects of the present invention;

FIG. 2 representatively illustrates an enlarged view of the centric space in accordance with an exemplary embodiment of the present invention;

FIG. 3 representatively illustrates the centric space with a first modular option in accordance with an exemplary embodiment of the present invention;

FIG. 4 representatively illustrates the centric space with a second modular option in accordance with an exemplary embodiment of the present invention;

FIG. 5 representatively illustrates the centric space with a third modular option in accordance with an exemplary embodiment of the present invention;

FIG. 6 illustrates a flow chart for creating a finalized floor plan in accordance with an exemplary embodiment of the present invention; and

FIG. 7 representatively illustrates database system in accordance with an exemplary embodiment of the present invention.

Elements and steps in the figures are illustrated for simplicity and clarity and have not necessarily been rendered according to any particular sequence. For example, steps that may be performed concurrently or in a different order are illustrated in the figures to help to improve understanding of embodiments of the present invention.

### DETAILED DESCRIPTION OF EXEMPLARY EMBODIMENTS

The present invention may be described in terms of functional block components and various processing steps. Such functional blocks may be realized by any number of hardware or software components configured to perform the specified functions and achieve the various results. For example, the present invention may employ various architectural design systems, databases, input devices, and the like, which may carry out a variety of functions. In addition, the present invention may be practiced in conjunction with any number of architectural designs, building materials, interior living accommodations, exterior living accommodations, and the system described is merely one exemplary application for the invention. Further, the present invention may employ any number of conventional techniques for building residential structures, routing plumbing and electrical utilities, and the like.

System and methods for modular design according to various aspects of the present invention may operate in conjunction with any suitable residential development system. Various representative implementations of the present invention may be applied to any system for building homes. Certain representative implementations may include, for example, pre-planned communities, housing developments, and model home complexes.

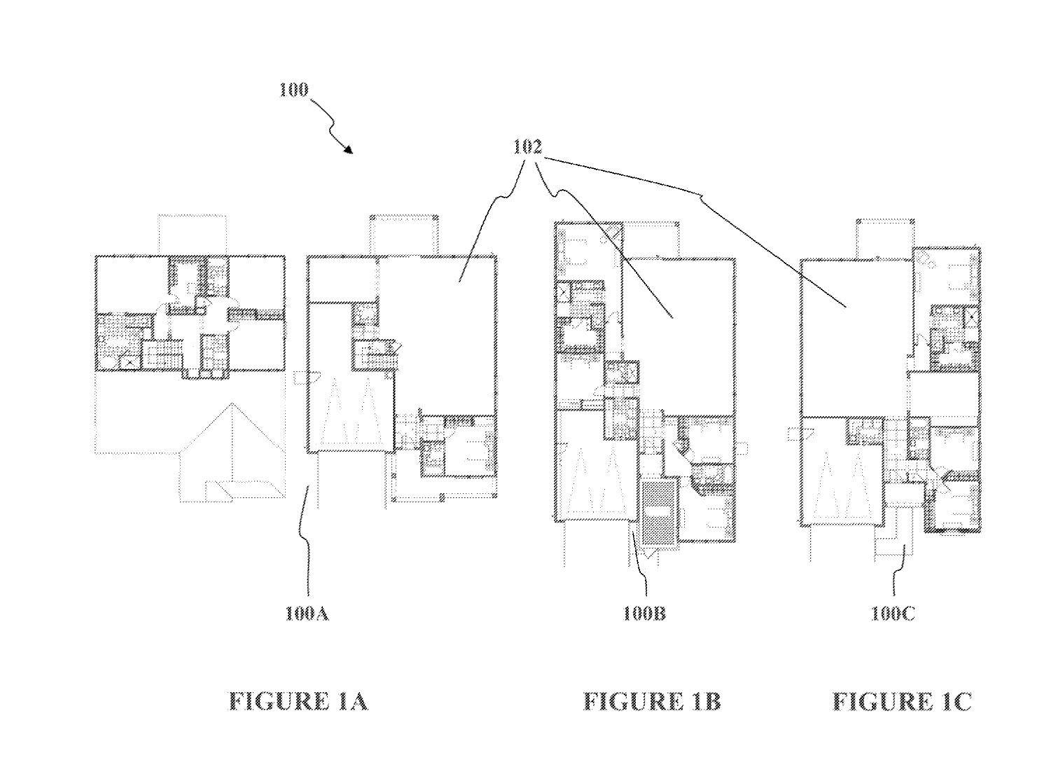

Referring now to FIG. 1, a modular design system according to various aspects of the present invention may comprise a set of various individual floor plans 100 for providing potential homebuyers a choice of housing options. The set of individual floor plans 100 may comprise any number or type of floor plans. For example, in one embodiment, set of individual floor plans 100 may comprise a collection of floor plans including a two-story home 100A, a four bedroom single story home 100B, or a three bedroom single story home 100C. In as second embodiment, the set of individual floor plans 100 may comprise between two and twelve individual floor plans including single and two-story homes. In a yet another embodiment, the set of individual floor plans 100 may comprise a plurality of different series of homes, wherein each series comprises a group of floor plans.

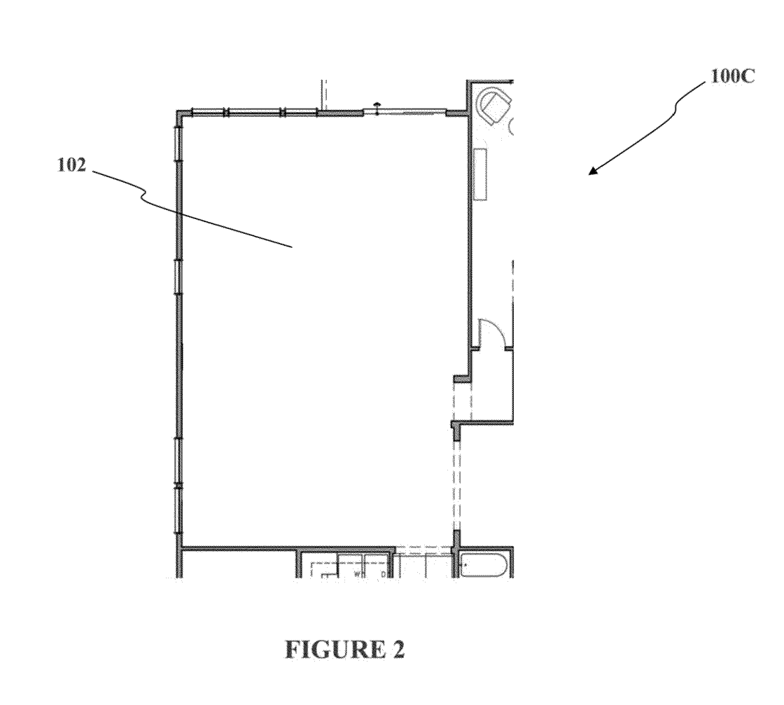

Referring now to FIGS. 1 and 2, each individual floor plan from the set of floor plans 100 may comprise a designated centric living space 102. The centric living space 102 defines an open space within each individual floor plan 100A, 100B, 100C that does not contain any specific design details, elements, or features. For example, each individual floor plan 100A, 100B, 100C may comprise a complete plan detail of all interior rooms and living spaces except for the centric living space 102.

The centric living space 102 may comprise any suitable space within a floor plan area. In one embodiment, the centric living space 102 may comprise a space wholly within an interior portion of the floor plan. In an alternative embodiment, the centric living space 102 may comprise a space that includes an area at least partially within the interior portion of the floor plan and a space located outside of the interior portion of the floor plan. For example, the centric living space 102 may comprise an exterior area that is immediately adjacent to an interior section of the floor plan such as a patio or outdoor kitchen.

The centric living space 102 may comprise any suitable shape, dimension, or area within each individual floor plan. For example, the centric living space 102 may comprise one or more adjacent rooms within a home. In one embodiment, the centric living space 102 may comprise a home's common living areas and includes areas such as a kitchen, living room, dining room, great room, and the like. In embodiment, the centric living space 102 may comprise approximately forty to sixty percent of the livable area in a first floor of a two-story home 100A. In a second embodiment, the centric living space 102 may comprise between twenty-five and forty percent of the livable area in a single story home 100B, 100C.

The centric living space 102 may further be configured to comprise the same shape, dimension, or area within each individual floor plan 100A, 100B, 100C such that the centric living space 102 is identical across the set of floor plans 100. Referring, now to FIGS. 2-5, the modular design system may further comprise a set of modular options suitably configured to provide a final floor plan by completing the design configuration of the centric living space 102. The set of modular options may comprise any suitable configuration or design for filling the open space of the centric living area 102 in the set of floor plans 100. In one embodiment, the modular options may comprise a set of configurations directed towards providing homebuyers with a choice of options that may be reflective of their desired living preferences with respect to any suitable criteria such as entertaining, a large and/or well appointed cooking area, making use of outdoor areas such as patios, and the like.

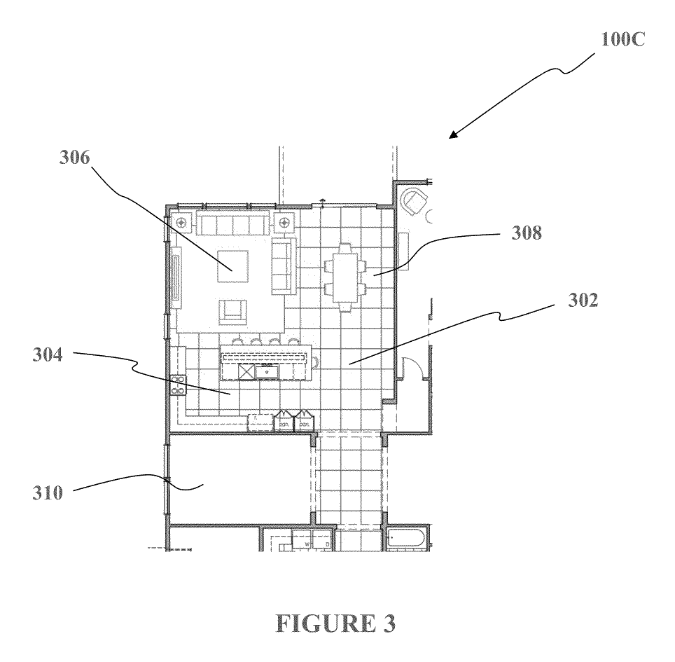

For example, referring now to FIG. 3, a first modular option 302 may comprise a configuration that fills the centric living space 102 with a kitchen 304, a living room 306, a dining area 308, and an extra room 310. The first modular 302 may further comprise the necessary details to supplement any individual floor plan, such as a single story home 100C, with the required information to form a completed floor plan.

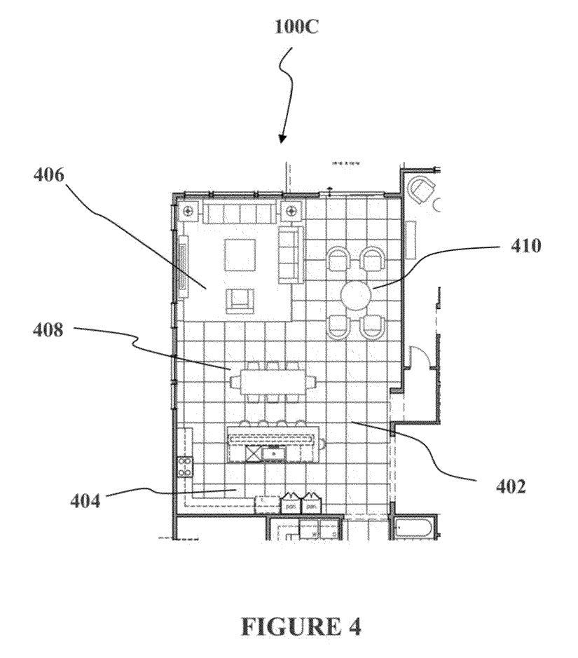

Referring now to FIG. 4, a second modular option 402 may comprise details to form a completed floor plan for the single story home 100C such that the centric living space is utilized in a different manner. For example, the second modular option 402 may comprise as configuration that fills the centric living space 102 with a kitchen 404, a living room 406, a dining area 408, and a social meeting area 410.

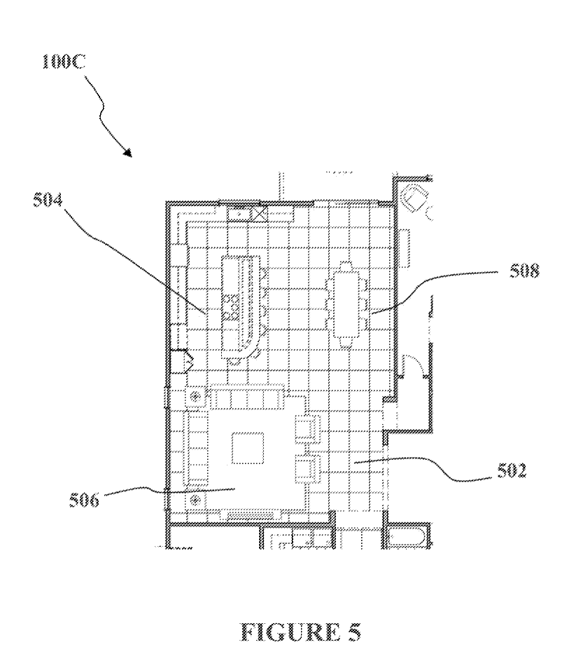

Referring now to FIG. 5, a third modular option 502 may comprise details to form a completed floor plan for the single story home 100C such that the centric living space is utilized in yet a wholly different manner. For example, the third modular option may comprise a configuration that tills the centric living space 102 with a comparably larger kitchen 504, a living room 506, and a dining area 508.

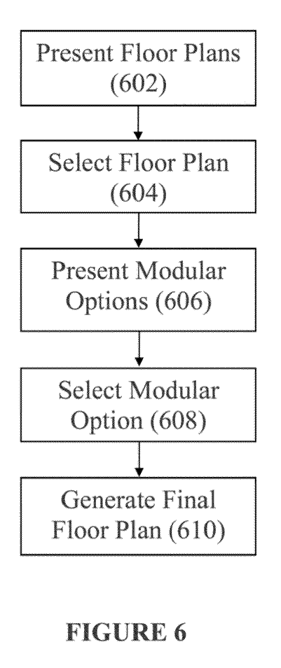

Referring now to FIG. 6, in one representative embodiment, a potential homebuyer may be presented with the set of floor plans 100 (602). The homebuyer may be shown the set of floor plans 100 by any suitable method or process. For example, the homebuyer may be given the opportunity to walk through a sample of pre-built model homes that provide a representative sample of a completed home based upon one or more of the individual floor plans 100A, 100B, 100C. The pre-built model homes may also be suitably configured with one of the modular options such that each of the modular options may be included across the pre-built model homes providing the homebuyer with a detailed view of each modular option in its completed form.

Alternatively, the homebuyer may be shown the set of floor plans 100 electronically, such as over the internet or on a computer terminal, and provided with a virtual tour of each individual floor plan. Each modular option may then be electronically substituted into the centric living space providing the homebuyer with a method of comparing floor plans and modular options.

The homebuyer may then be prompted to select a floor plan from the set of floor plans 100 that they wish to purchase (604). Once the floor plan is selected, the homebuyer may be presented with the set of modular options (606) and prompted to select which modular option should be inserted in the centric living space 102 of the selected floor plan (608). The homebuyer's choices may then be recorded or otherwise saved and used to generate a final floor plan of the home that will be built (410).

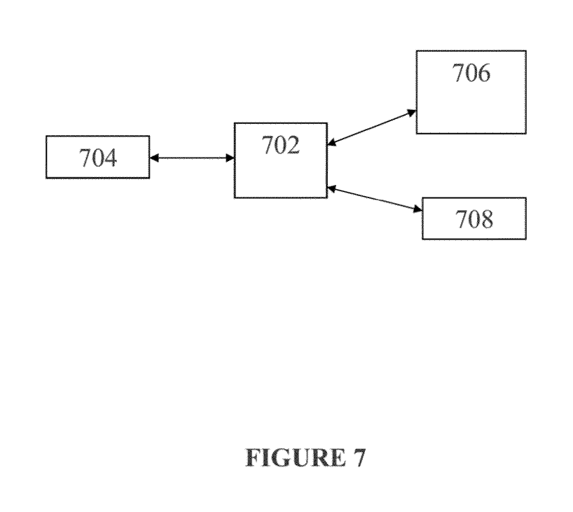

Referring now to FIG. 7, a modular design system according to various aspects of the present invention may comprise a database 702 communicatively linked to a server 706 having a memory device and a processor. The database 702 may also be communicatively linked to an input device 704 such as a computer terminal and an architectural design system 708.

The database 702 may comprise any suitable device or system for storing data, providing access to the stored data, and saving new data. In one embodiment, the database 702 may be configured to store the set of floor plans 100 and the set of modular options on the server 706. The database 702 may also be configured to save the homebuyers selected combination of floor plan and modular option. For example, the database 702 may be configured to receive the selected combination from the input device 704 and store the combination with an identifier linking the selected combination to the particular homebuyer that made the selection. The identifier may comprise any suitable method of linking the homebuyer to the selected combination such as the homebuyer's name, a lot number that the home will be built on, the physical address of the lot, and the like.

The database 702 may further be configured to combine the selected Combination of floor plan and modular option to form a finalized floor plan. In one embodiment, the database 702 may comprise specific configuration details for each individual floor plan and each modular option and contain the necessary logic instructions for adding the specific configuration details for a given modular option into any selected individual floor plan thereby generating a finalized floor plan.

For example, for each individual floor plan, the database 702 may comprise structural details such as: the location of walls, doors, and windows; the location of electrical services such as wall outlets and switches; the required routing for plumbing; and the location and routing of the ventilation system. These structural details may be complete fur each individual floor plan except for centric living area 102. The database 702 may further comprise the structural details for each modular option and be suitably configured to insert or otherwise add these details into a given floor plan to form a finalized floor having a complete description allowing the home to be built, materials ordered, and/or contractors scheduled.

In a second embodiment, the database 702 may comprise a finalized list of each individual floor plan configured with each modular option. The database 702 may then be configured to receive data from the input device 704 indicating a homebuyer's selected options and search the finalized list, identify the matching finalized option, and then create a new entry linking the homebuyer to the appropriate finalized floor plan.

The finalized floor plan may then be accessed by the architectural design system 708 for review and/or additional modification. For example, an architect may utilize the architectural design system 708 to add in any details required for local permitting requirement, include any additional homebuyer options into the finalized floor plan, or review the finalized floor plan for quality assurance.

These and other embodiments for methods of modular design may incorporate concepts, embodiments, and configurations as described with respect to embodiments of apparatus for completing a floor plan as described above. The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting Ines shown in the various figures are intended to represent exemplary functional relationships and/or physical couplings between the various elements. Many alternative or additional functional relationships or physical connections may be present in a practical system.

The invention has been described with reference to specific exemplary embodiments. Various modifications and changes, however, may be made without departing from the scope of the present invention. The description and figures are to be regarded in an illustrative manner, rather than a restrictive one and all such modifications are intended to be included within the scope of the present invention. Accordingly, the scope of the invention should be determined by the generic embodiments described a d their legal equivalents rather than by merely the specific examples described above. For example, the steps recited m any method or process embodiment may be executed in any order, unless otherwise expressly specified, and are not limited to the explicit order presented in the specific examples. Additionally, the components and/or elements recited in any apparatus embodiment may be assembled or otherwise operationally configured in a variety of permutations to produce substantially the same result as the present invention and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a nonexclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to chose not specifically recited, may be varied or otherwise particularly adapted to specific environments, manufacturing specifications, design parameters or other operating requirements without departing from the general principles of the same.

The present invention has been described above with reference to a preferred or exemplary embodiment. However, changes and modifications may be made to the preferred embodiment without departing from the scope of the present invention. These and other changes or modifications are intended to be included within the scope of the present invention, as expressed in the following claims.

1. A method for providing a selectable living area within a floor plan to a home buyer, comprising:
presenting to the home buyer a set of individual floor plans, wherein each floor plan from the set of individual floor plans comprises a designated centric living space;
presenting to the home buyer a set of modular options, wherein each modular option is configured to be located within the designated centric living space of each floor plan from the set of individual floor plans;
receiving from the home buyer a selection comprising:
a floor plan from the set of initial floor plans; and
a modular option from the set of modular options and
generating a final floor plan incorporating the selected modular option into the designated centric living space of the selected floor plan.

2. A method according to claim 1, wherein the designated centric living space comprises a pre-defined area within each individual floor plan.

3. A method according to claim 2, wherein the pre-defined area comprises a section absent interior room configuration details.

4. A method according to claim 2, wherein the pre-defined area comprises the same square footage in each individual floor plan.

5. A method according to claim 1, wherein each modular option comprises:
a kitchen area; and
a common living area.

6. A method according to claim 5, wherein:
a first modular option comprises a first configuration of the kitchen area and the common living area within the designated centric living space; and
a second modular option comprises a second configuration of the kitchen area and the common living area within the designated centric living space.

7. A system for generating a selectable living area within a floor plan, comprising,:
a database containing:
a set of initial floor plans, wherein each initial floor plan comprises a designated centric living space;
a set of modular options, wherein each modular option is configured to be located within the designated centric living space of each initial floor plan; and
an input device communicatively linked to the database and configured to receive an input comprising:
a selected initial floor plan from among the set of initial floor plans; and
a selected modular option from among the set of modular options,
wherein the database is configured to:
generate a final floor plan incorporating the selected modular option into the designated centric living space of the selected initial floor plan; and
save the final floor plan.

8. A system for generating a selectable living area within a home according to claim 7, further comprising:
a server communicatively linked to the database; and
a architectural design system linked to the database and configured to modify the final floor plan.

9. A system for generating a selectable living area within a home according to claim 7, wherein the designated centric living space comprises a pre-defined area within each initial floor plan.

10. A method according to claim 9, wherein the pre-defined area comprises a section absent interior room configuration details.

11. A system generating a selectable living area within a home according to claim 7, wherein each modular option comprises:
a kitchen area; and
a common living area.

12. A system for generating a selectable living area within a home according to claim 11, wherein:
a first modular option comprises a first configuration of the kitchen area and the common living area within the designated centric living space; and
a second modular option comprises as second configuration of the kitchen area and the common living area within the designated centric living space.

13. A method of creating a floor plan for a home having a selectable living area, comprising:
creating a set of individual floor plans, wherein each individual floor plan:
is saved to a database; and
comprises a designated centric living space;
creating a set of modular options, wherein each modular option is:
saved to the database; and
configured to be located within the designated centric living space of each individual floor plan;
receiving an input comprising:
a selected floor plan from the set of individual floor plans; and
a selected modular option from the set of modular options; and
generating a final floor plan incorporating the selected modular option into the designated centric living space of the selected individual floor plan.

14. A method according to claim further comprising saving the final floor plan to the database.

15. A method according to claim 13, wherein the centric living space comprises a common square footage area within each initial floor plan.

16. A method according to claim 15, wherein the pre-defined area comprises a section absent interior room configuration details.

17. A method according to claim 15, wherein the pre-defined area comprises the same square footage in each individual floor plan.

18. A method according to claim 13, wherein each modular ion comprises:
a kitchen area; and
a common living area.

19. A method according to claim 18, wherein:
a first modular option comprises a first configuration of the kitchen area and the common living area within the centric living space; and
a second modular option comprises a second configuration of the kitchen area and the common living area within the centric living space.
